(19) United States
(12) Patent Application Publication
(10) Pub. No.: US 2024/0368961 A1
(43) Pub. Date: Nov. 7, 2024

(54) PROTECTING THE CASING-CASING ANNULUS IN HYDROCARBON PRODUCING WELLBORES

(71) Applicant: SAUDI ARABIAN OIL COMPANY, Dhahran (SA)

(72) Inventors: Jawad ZAHUR, Abqaiq (SA); Abdullah ALJINDAN, Abqaiq (SA); Saud A. ALSHUWAIER, Abqaiq (SA)

(73) Assignee: SAUDI ARABIAN OIL COMPANY, Dhahran (SA)

(21) Appl. No.: 18/310,221

(22) Filed: May 1, 2023

(51) Int. Cl. E21B 33/047; E21B 33/05; E21B 33/12

(52) U.S. Cl. CPC E21B 33/138; C09K 8/50; E21B 33/047; E21B 33/05; E21B 33/12

(57) ABSTRACT

A wellbore system includes a wellhead positioned at a well surface and capping a wellbore extending from the wellhead, and a plurality of strings of casing arranged within the wellbore and extending from the wellhead. The plurality of strings of casing include an intermediate casing, and a production casing arranged within the intermediate casing and thereby defining a casing-casing annulus between the production casing and the intermediate casing. Production tubing extends from the wellhead and is arranged within the production casing, and corrosion inhibiting diesel fluid is present within the casing-casing annulus and thereby forms a corrosion-inhibiting barrier within the wellbore.

### FIELD OF THE DISCLOSURE

The present disclosure relates generally to maintaining wellbore integrity and, more particularly, to the placement and management of well barriers within the production annuli of hydrocarbon producing oil and gas wellbores to maintain wellbore integrity over the life of the well.

### BACKGROUND OF THE DISCLOSURE

Well integrity is a combination of operations, apparatuses, and solutions that together enable the containment and control of downhole fluids. Well integrity serves to reduce the risk of an uncontrolled release of fluids to the surface of a wellbore and prevents the inadvertent movement of fluid through the wellbore during the life of the well.

The wellbore construction phase is particularly crucial to ensuring adequate well integrity over the life of the well. Accordingly, the oil and gas industry has implemented systems, components, methods, and best practices to safely and efficiently construct a wellbore. Such components, methodologies, and best practices must align with the requirements of both the operator and the applicable regulatory bodies governing the standards of hydrocarbon producing wells. Cement is the most utilized method of annular tubular support and zonal isolation. However, placement and consistency in quality of the cement can often be difficult which may ultimately lead to a variety of well integrity issues.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a wellbore system may include a wellhead positioned at a well surface and capping a wellbore extending from the wellhead and a plurality of strings of casing arranged within the wellbore and extending from the wellhead. Wherein the plurality of strings of casing may include an intermediate casing and a production casing arranged within the intermediate casing and thereby defining a casing-casing annulus between the production casing and the intermediate casing as well as a production tubing extending from the wellhead and arranged within the production casing. A corrosion inhibiting diesel fluid may fill the casing-casing annulus and thereby form a corrosion-inhibiting barrier within the wellbore.

According to an embodiment consistent with the present disclosure, a method may include extending a plurality of strings of casing into a wellbore extending from a wellhead arranged at a well surface. The plurality of strings of casing may include an intermediate casing and a production casing arranged within the intermediate casing, thereby defining a casing-casing annulus between the production casing and the intermediate casing. The method may further include pumping corrosion inhibiting diesel fluid into the casing-casing annulus and thereby forming a corrosion-inhibiting barrier within the wellbore.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of an example wellbore system that may embody or otherwise employ one or more principles of the present disclosure.

FIG. 2 is a schematic flowchart of an example well construction method that may incorporate the principles of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to well integrity and, more particularly, to the placement and management of well barriers within the production annuli of hydrocarbon producing oil and gas wellbores in order to maintain wellbore integrity over the life of the well.

Well or wellbore integrity, while integral to all phases of the life of the well, is particularly critical during the initial construction of the wellbore. During wellbore construction, permanent (or semi-permanent) well barriers are installed to prevent downhole fluids (e.g., formation fluids, injected fluids, etc.) from uncontrollably or inadvertently flowing to surface during the construction period and throughout the life of the well. As a well is incrementally drilled, each borehole section will be supported by a tubular (e.g., casing, liner, etc.) extended into the borehole. In most intervals, once properly positioned within the borehole, the tubular will be cemented into place by filling the annulus between the exterior of the tubular and the interior of the drilled borehole with cement. In some cases, the entirety of the annuli will be cemented up to the well surface, or in the case of a liner, to the top of the liner. In other cases, only a pre-determined portion of the annuli will be cemented.

Cement, however, can sometimes be ineffective as a well integrity barrier for a variety of reasons. Such reasons include, but are not limited to, poor quality of cement, improper centralization of the tubular, inadequacy of drilling fluid removal, as well as the effects of temperature and production. If the cement fails, the well barrier may no longer be sufficient and remediation could be necessary, which often requires costly, corrective actions to reinstate the barrier and maintain proper well integrity. The failure of cement may also lead to the unintended corrosion of the tubulars, which may ultimately lead to failure and leaks, thus requiring production shut down and expensive tubular replacement operations. Ultimately, proper wellbore construction provides the well integrity required for safety of the environment and may extend the longevity and viability of a hydrocarbon producing well.

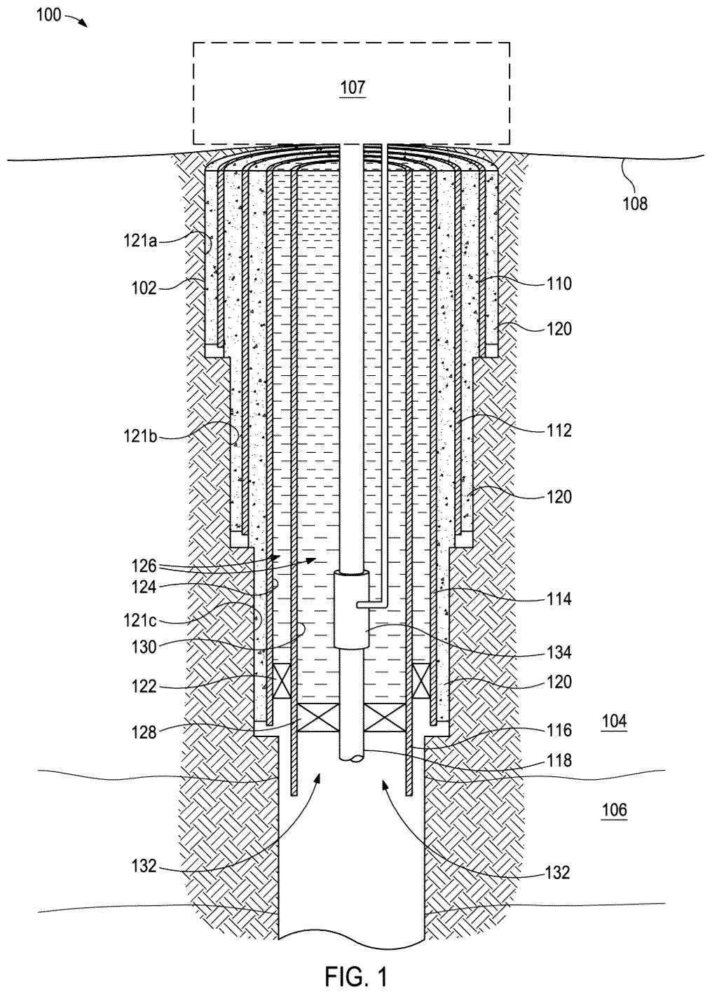

FIG. 1 is a schematic diagram of an example wellbore system 100 that may embody or otherwise employ one or more principles of the present disclosure. In the illustrated embodiment, the wellbore system 100 includes a wellbore 102 that includes a plurality of casing strings extended therein. Although FIG. 1 illustrates the wellbore 102 in a finished or complete state, the components will be described individually and in some cases, procedural (operational) order to reflect the progressive installation of well barriers in accordance with the embodiments of the present disclosure.

The wellbore 102, as illustrated, may penetrate a subterranean oil and gas formation 104 comprising a producible reservoir 106. The wellbore 102 may extend from a wellhead 107 (shown as a dashed box) that may be positioned on (or at) a well surface 108. In the illustrated embodiment, the well surface 108 is the seafloor, accordingly the wellbore system 100 may form part of an offshore drilling or production application. It will be appreciated, however, that the various embodiments discussed herein are equally well suited for use in conjunction with other types of wellbore systems corresponding to land-based applications or oil and gas rigs and/or platforms located at any geographical site.

As illustrated, the wellbore 102 may be lined with one or more concentric strings of tubulars, referred to herein as “casing.” Each string of casing may comprise distinguishable characteristics including, but not limited to, metallurgies, wall thicknesses, and yield strengths. Based on the needs and requirements specific to the well system 100, the well operator may determine the type, quantity, and characteristics of the casings necessary to install within the wellbore 102. Those of ordinary skill will be familiar with such characteristics and well construction requirements, and as such, these considerations will not be discussed in further detail.

In the illustrated embodiment, the wellbore 102 may have extended therein a conductor casing 110, a surface casing 112, an intermediate casing 114, and a production casing 116, wherein each casing 110, 112, 114 extends back to the well surface 108 (long-string) and may be operatively coupled to and in fluid communication with a respective casing head housing forming part of the wellhead 107. As used herein, the term “operatively coupled,” and any grammatical variants thereof, refers to a direct or indirect coupling engagement between two components. As illustrated, the surface casing 112 is concentrically arranged within the conductor casing 110, and the intermediate casing 114 is concentrically arranged within the surface casing 112.

The conductor casing 110, the surface casing 112, and the intermediate casing 114 may all be at least partially supported by a corresponding column of cement 120. More specifically, a first borehole annulus 121a may be defined between the conductor casing 110 and an adjacent inner wall of the wellbore 102, and a first column of cement 120 may be deposited in and fill the first borehole annulus 121a. A second borehole annulus 121b may be defined between the surface casing 112 and portions of both the adjacent inner wall of the wellbore 102 and the conductor casing 110, and a second column of cement 120 may be deposited in and fill the second borehole annulus 121b. And a third borehole annulus 121c may be defined between the intermediate casing 114 and portions of both the adjacent inner wall of the wellbore 102 and the surface casing 112, and a third column of cement 120 may be deposited in and fill the third borehole annulus 121c.

In some embodiments, where the pressure regime of the formation 104 may require multiple strings of the intermediate casing 114, the intermediate casing 114 may alternatively be installed as a liner. In such embodiments, the top (uppermost portion) of the intermediate casing 114 may be positioned within and secured to the immediate radially-outward string of casing (e.g., the surface casing 112). Moreover, in such embodiments, the top of the intermediate casing 114 may be positioned a predetermined distance above the distal end of the immediate radially-outward string of casing and secured thereto via a liner hanger or by other known means. Furthermore, in such embodiments, one or more additional strings of intermediate casing 114 may be extended into the wellbore concentric with the first intermediate casing 114, and each additional string of intermediate casing 114 may be cemented in place. The one or more additional strings of intermediate casing 114 may extend from the wellhead 107 and otherwise from the well surface 108 to provide one or more corresponding sealed annuli (compartments) between the multiple strings of intermediate casing 114.

As illustrated, the cement 120 within each annulus 121a-c extends back to the well surface 108, thus helping to radially support the concentrically-aligned casings 110, 112, 114 with a full column of cement 120. Accordingly, the cement 120 structurally supports and secures each respective casing 110, 112, 114. Additionally, the cement 120 also operates as a potential barrier to fluid flow from shallow hazards (e.g., shallow water flow, shallow gas, etc.) that may be present within the upper layers of the subterranean surface. Similarly, the cement 120 may be a barrier for corrosion to the supported tubulars (e.g., conductor casing 110, surface casing 112, etc.) that may otherwise be exposed to corrosion inducing formation fluids (e.g., formation water and water from shallow aquifers).

In some embodiments, the wellbore system 100 may further include a production casing 116 and a production tubing 118 each extending from the wellhead 107. The production casing 116 may be concentrically arranged within the inner-most intermediate casing 114, and the production tubing 118 may be concentrically arranged within the interior of the production casing 116. Similar to the other strings of casing 110, 112, 114, the production casing 116 may be operatively coupled to and in fluid communication with a respective casing head housing forming part of the wellhead 107. Moreover, the upper end of the production tubing 118 may be secured within a tubing head housing included in the wellhead 107. A casing-casing annulus 124 may be defined between the production casing 116 and the intermediate casing 114, and a tubing-casing annulus 130 is defined between the production tubing 118 and the production casing 116.

As illustrated, both the production tubing 118 and the production casing 116 extend toward the distal end of the wellbore 102. In some embodiments, the production tubing 118 may extend past the distal end of the production casing 116. In such cases, the distal end of the production tubing 118 may be positioned within an open-hole portion of the wellbore 102. The production tubing 118 may be operable to receive and convey formation fluids to the well surface 108. The formation fluids may comprise, for example, hydrocarbons 132 (e.g., oil and gas) that migrate from the reservoir 106 into the wellbore 102.

In the oil and gas industry, it is common practice to design and execute (e.g., drill, complete, and produce) a well so that there may be a minimum of two independent and verified (tested) barriers to any potential flow path (hydrocarbon or otherwise) during all phases of the wellbore 102, beginning with well construction and continuing through the producing life of the well, to maintain well integrity. Cement is most often utilized as one such barrier as positioned behind a tubular to a predetermined height (e.g., to surface, 500 ft. above the casing shoe, etc.). Beyond placement of the cement barrier, there are additional requirements that must be met to qualify the cement as an independent well barrier. Example requirements include, but are not limited to, volume, quality, and compressive strength of the cement. Further, the requirements qualifying (verifying) the cement as a well barrier are dependent upon both the requirements of the well operator and the applicable regulatory bodies.

However, in a wellbore where cement has been utilized as a primary well barrier behind multiple strings of casing (or tubulars), issues can arise later when the well is in production. Annular pressure buildup (APB), for example, may be experienced as a result of thermal expansion that commonly occurs as the well receives volumes of hot formation fluids (e.g., oil, gas, and water). APB may be observed via a wellhead annular access valve in fluid communication with the tubing-casing annulus 130 defined between the production tubing 118 and the production casing 116. The APB exerted on the production casing 116 may cause micro-fractures or micro-channels within the cement placed behind the production casing 116, and micro-fractures may be further exacerbated by poor quality cement resulting from poor cementing practices. The micro-fractures may provide channels or conduits through which formation fluids from the reservoir 106 may flow, resulting in unintended contact with the exterior of the production casing 116 and a weakening of the cement to production casing 116 bond. Over time, this contact may result in corrosion and the eventual deterioration of the production casing 116. Such deterioration may result in well shut down to perform remedial operations including but not limited to cement squeezes, casing patch installation, resin injection, as well as cutting and re-stubbing of casing.

According to embodiments of the present disclosure, the production section of the wellbore 102 may be constructed with two independent and verified well barriers that do not include the placement of cement behind the production casing 116 in the casing-casing annulus 124 defined between the production casing 116 and the intermediate casing 114. Instead, as illustrated, the production casing 116 may be run downhole with an annulus packer 122, which may be deployed within the casing-casing annulus 124. Once the annulus packer 122 is properly set within the casing-casing annulus 124, a corrosion inhibiting diesel fluid 126 may be conveyed into the casing-casing annulus 124 to help form a corrosion-inhibiting barrier within the wellbore 102 and thereby extend the life of the intermediate and production casings 114, 116. In such embodiments, the wellhead 107 and the combination annulus packer 122 and corrosion inhibiting diesel fluid 126 may constitute verified and independent barriers for the wellbore 102. The corrosion inhibiting diesel fluid 126 may also prove advantageous in mitigating any pressure abnormalities in the casing-casing annulus 124, which would otherwise expose cement in the casing-casing annulus 124 to hydrocarbon or aquifer fluids and potentially results in creating micro-fractures between the production casing 116 and the cement.

The annulus packer 122 may be operatively coupled to the production casing 116 such that the annulus packer 122 is arranged within the wellbore 102 at a predetermined setting depth. In the illustrated embodiment, the distal end of the production casing 116 may be positioned at a predetermined distance above (uphole from) the bottom of the wellbore 102, but could alternatively be positioned at or near the bottom of the wellbore 102. In either scenario, the annulus packer 122 may be positioned such that deploying the annulus packer 122 helps define the bottom of the casing-casing annulus 124.

The annulus packer 122 may comprise any known wellbore isolation device that includes radially expandable elements capable of extending radially outward and engaging the inner wall of the intermediate casing 114. In some embodiments, for example, the radially expandable elements may constitute a stainless steel sleeve that may be operable to expand upon the application of hydraulic pressure. In other embodiments, the radially expandable elements may be made of a polymer or an elastomer. Some elastomeric expandable elements may be operable to swell upon contact with a selected fluid (e.g., oil-based fluid, and/or water-based fluid). In other embodiments, the expandable elements may be actuated (expanded) via mechanical force wherein the application of compression or tension to the coupled tubular activates the expansion of the elements.

After the production casing 116 is properly positioned within the wellbore 102, but prior to actuating (deploying) the annulus packer 122, the corrosion inhibiting diesel fluid 126 may be circulated into the casing-casing-annulus 124. To accomplish this, the corrosion inhibiting diesel fluid 126 is first circulated into the production casing 116, and continued pumping causes the corrosion inhibiting diesel fluid 126 to flow around the distal end of the production casing 116 and into the casing-casing annulus 124. As the corrosion inhibiting diesel fluid 126 circulates through the production casing 116 and up the casing-casing annulus 124, drilling fluid and other fluids present within the production casing 116 and the casing-casing annulus 124 may be entirely displaced. Such fluids may be discharged from the wellbore 102 at the wellhead 107 via suitable plumbing and valves in fluid communication with the casing-casing annulus 124.

The corrosion inhibiting diesel fluid 126 may comprise a percentage of diesel fuel commingled with a percentage of corrosion inhibitor. In at least one embodiment, the corrosion inhibiting diesel fluid 126 may comprise diesel fuel mixed with 2% by volume, liquid amine corrosion inhibitor. Corrosion inhibitors are chemical additives operable to reduce the rate of metal deterioration caused by chemical reactions due to the presence of H₂S, CO₂, and O₂, that may occur within the wellbore 102. More particularly, corrosion inhibitors may be effective in reducing the damage to downhole tubulars, such as the production casing 116 and the production tubing 118, which may have direct contact with corrosion inducing fluids. Due to the market availability of corrosion inhibitors, and their varying applicability, the operator may utilize a corrosion inhibitor and by volume percentage that is best suited to the needs and requirements of the well.

Once the corrosion inhibiting diesel fluid 126 is pumped into the casing-casing annulus 124, as described above, the annulus packer 122 may then be activated (deployed) to provide a fluid seal at the bottom of the casing-casing annulus 124. Once properly deployed, the annulus packer 122 isolates the casing-casing annulus 124 above the annulus packer 122 and serves as a mechanical well barrier to flow between the producible reservoir 106 and the casing-casing annulus 124. As will be appreciated, this may negate the need for a cement barrier in the casing-casing annulus 124. In order to qualify as a well barrier, however, the corrosion inhibiting diesel fluid 126 within the casing-casing annulus 124 must be sufficiently tested and deemed sufficient to prevent flow. Similarly, to qualify the annulus packer 122 as a well barrier, the annulus packer 122 may be tested in accordance with the procedural requirements of the selected packer 122.

In some embodiments, the production tubing 118 may be conveyed into the wellbore 102 in conjunction with a production packer 128 operatively coupled to the production tubing 118 at or near its distal end. Similar to the annulus packer 122, the production packer 128 may include any of a variety of radially expandable elements and methods of actuation. Accordingly, the production packer 128 may be the same as or similar to the annulus packer 122 and, therefore, will not be described in further detail. The production packer 128 may be positioned such that deploying the production packer 128 helps define the bottom of the tubing-casing annulus 130.

The combination production tubing 118 and production packer 128 may be extended into and arranged within the wellbore 102 to a predetermined depth. In the illustrated embodiment, the distal end of the production tubing 118 is positioned an established distance above (uphole) the distal end (shoe) of the production casing 116. The production packer 128 may be arranged within the tubing-casing annulus 130 defined between the production tubing 118 and the production casing 116, and when the production packer 128 is activated (deployed), its radially expandable elements may extend radially outward to engage the inner walls of the production casing 116 and thereby secure the lowermost portion of the production tubing 118 to the production casing 116.

Once deployed, the production packer 128 further provides a fluid seal in the tubing-casing annulus 130. More specifically, the production packer 128 may be operable as a mechanical well barrier to fluid flow between the producible reservoir 106 and the tubing-casing annulus 130. Similar to the packer 122, to qualify as a well barrier, the production packer 128 must be sufficiently tested in accordance with the requirements of the well operator and the applicable regulatory bodies to be deemed sufficient to prevent flow.

In some embodiments, the wellbore system 100 may include additional downhole components or tools that remain within the wellbore 102 during the producing life of the well. In one embodiment, for example, the production tubing 118 may further include a downhole electric submersible pump (ESP) 134 to provide artificial lift of the hydrocarbons 132. In other embodiments, the production tubing 118 may include gas lift apparatuses or valves for the same purpose of increasing production. In either embodiment, the pressure within the tubing-casing annulus 130 may be further increased (beyond that of unassisted hydrocarbon production) resulting in the expansion of the production casing 116.

According to embodiments of the present disclosure, corrosion inhibiting diesel fluid 126 may also be provided in the tubing-casing annulus 130 to help decrease the likelihood of tubular deterioration of the production casing 116 and the production tubing 118. In some embodiments, the corrosion inhibiting diesel fluid 126 may already be present within the production casing 116 as a result of the process of circulating the corrosion inhibiting diesel fluid 126 into the casing-casing annulus 124, as generally described above. In such embodiments, the production tubing 118 may be extended into the production casing 116, which is already filled with the corrosion inhibiting diesel fluid 126. Once the production tubing 118 reaches a predetermined depth within the wellbore 102, the production packer 128 may be deployed to provide a fluid seal in the tubing-casing annulus 130, and thereby isolate the tubing-casing annulus 130 above the production packer 128.

In other embodiments, fluids present within the interior of the production casing 116 may first need to be circulated out of the production casing 116 prior to pumping the corrosion inhibiting diesel fluid 126 into the production casing 116. In such embodiments, the combination production tubing 118 and production packer 128 may be conveyed into the production casing 116, following which the corrosion inhibiting diesel fluid 126 may be pumped (by bullheading) and discharged into the production casing 116. Continued pumping causes the corrosion inhibiting diesel fluid 126 to circulate uphole within the tubing-casing annulus 130, thereby displacing any fluids that may be present within the tubing-casing annulus 130. Such fluids may be discharged from the wellbore 102 at the wellhead 107 via suitable plumbing and valves in fluid communication with the tubing-casing annulus 130. Once the corrosion inhibiting diesel fluid 126 is pumped into the tubing-casing annulus 130, the production packer 128 may be deployed to provide a fluid seal in the tubing-casing annulus 130, and thereby isolate the tubing-casing annulus 130 above the production packer 128.

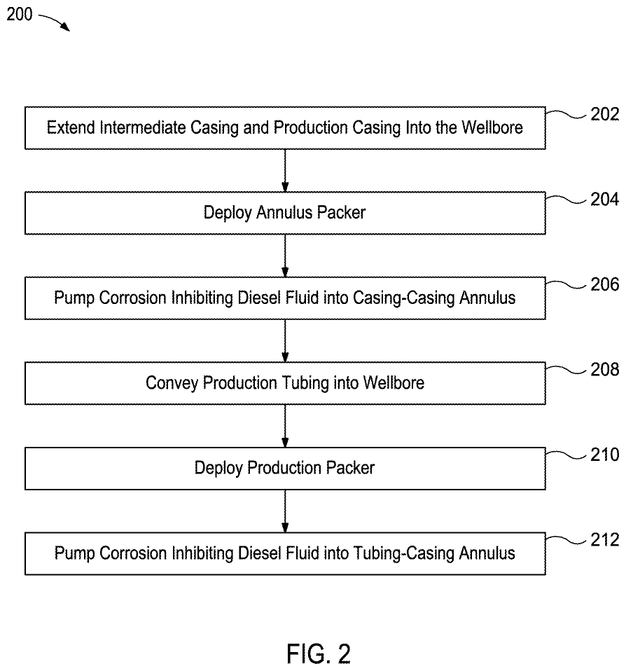

FIG. 2 is a schematic flowchart of an example method 200 of establishing well integrity, according to the principles disclosed herein. The method 200 may include extending a plurality of strings of casing into a wellbore extending from a wellhead arranged at a well surface, as at 202. The plurality of strings of casing may include at least an intermediate casing and production casing arranged within the intermediate casing, whereby a casing-casing annulus is defined between the production casing and the intermediate casing. The method 200 may further include deploying an annulus packer coupled to the production casing within the casing-casing annulus, as at 204. Deploying the annulus packer may help define a bottom of the casing-casing annulus.

The method 200 may then include pumping corrosion inhibiting diesel fluid into the casing-casing annulus, as at 206. The corrosion inhibiting diesel fluid within the casing-casing annulus may prove advantageous in forming a corrosion-inhibiting barrier within the wellbore, and may be further advantageous in mitigating pressure abnormalities in the casing-casing annulus, which would otherwise expose cement in the casing-casing annulus to hydrocarbon or aquifer fluids and potentially results in creating micro-fractures between the production casing and the cement.

In some embodiments, the method 200 may further include conveying production tubing into the production casing, as at 208, thereby defining a tubing-casing annulus between the production tubing and the production casing. A production packer may be coupled to the production tubing, and the method 200 may further include deploying the production packer within the tubing-casing annulus, as at 210. Deploying the production packer may help define a bottom of the tubing-casing annulus. The method 200 may then include pumping corrosion inhibiting diesel fluid into the tubing-casing annulus, as at 212, and thereby forming a second corrosion-inhibiting barrier within the wellbore.

In some embodiments, the wellbore may further include additional strings of casing, including a conductor casing and a surface casing arranged within the conductor casing. A first borehole annulus may be defined between the conductor casing and an adjacent inner wall of the wellbore, and a second borehole annulus may be defined between the surface casing and portions of both an adjacent inner wall of the wellbore and the conductor casing. A third borehole annulus may be defined between the intermediate casing and portions of both an adjacent inner wall of the wellbore and the surface casing. In one or more embodiments, a column of cement may be deposited in the first, second, and third borehole annuli.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including.” “comprises”, and/or “comprising.” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A wellbore system, comprising:
a plurality of strings of casing arranged within a wellbore and including:
an intermediate casing; and
a production casing arranged within the intermediate casing and thereby defining a casing-casing annulus between the production casing and the intermediate casing;
production tubing arranged within the production casing to define a tubing-casing annulus therebetween;
an electric submersible pump (ESP) coupled to the production tubing; and
corrosion inhibiting fluid filling:
the casing-casing annulus and thereby forming first a corrosion-inhibiting barrier within the wellbore; and
the tubing-casing annulus and thereby forming a second corrosion-inhibiting barrier within the wellbore.

2. (canceled)

3. (canceled)

4. The wellbore system of claim 1, further comprising a production packer operatively coupled to the production tubing and deployable from an unexpanded state to an expanded state within tubing-casing annulus to thereby define a bottom of the tubing-casing annulus.

5. The wellbore system of claim 1, wherein the plurality of strings of casing further includes:
a conductor casing extending from the wellhead, a first borehole annulus being defined between the conductor casing and an adjacent inner wall of the wellbore;
a surface casing arranged within the conductor casing, a second borehole annulus being defined between the surface casing and portions of both an adjacent inner wall of the wellbore and the conductor casing; and
a third borehole annulus defined between the intermediate casing and portions of both an adjacent inner wall of the wellbore and the surface casing.

6. The wellbore system of claim 5, further comprising:
a first column of cement deposited in the first borehole annulus;
a second column of cement deposited in the second borehole annulus; and
a third column of cement deposited in the third borehole annulus.

7. The wellbore system of claim 1, wherein the corrosion inhibiting fluid comprises diesel fuel and a percentage by volume of liquid amine corrosion inhibitor.

8. The wellbore system of claim 1, wherein the intermediate casing comprises two or more strings of intermediate casing.

9. A method, comprising:
extending a plurality of strings of casing into a wellbore, the plurality of strings of casing including:
an intermediate casing; and
a production casing arranged within the intermediate casing and thereby defining a casing-casing annulus between the production casing and the intermediate casing;
conveying production tubing into the production casing and thereby defining a tubing-casing annulus between the production tubing and the production casing, wherein an electric submersible pump (ESP) is coupled to the production tubing;
pumping corrosion inhibiting fluid into the casing-casing annulus and thereby forming a first corrosion-inhibiting barrier within the wellbore; and
pumping corrosion inhibiting fluid into the tubing-casing annulus and thereby forming a second corrosion-inhibiting barrier within the wellbore.

10. (canceled)

11. (canceled)

12. (canceled)

13. The method of claim 9, wherein extending the plurality of strings of casing into the wellbore further comprises:
conveying a conductor casing into the wellbore and thereby defining a first borehole annulus between the conductor casing and an adjacent inner wall of the wellbore; and
conveying a surface casing into the wellbore within the conductor casing and thereby defining a second borehole annulus between the surface casing and portions of both an adjacent inner wall of the wellbore and the conductor casing; and
defining a third borehole annulus between the intermediate casing and portions of both an adjacent inner wall of the wellbore and the surface casing.

14. The method of claim 12, further comprising:
depositing a first column of cement in the first borehole annulus;
depositing a second column of cement in the second borehole annulus; and
depositing a third column of cement deposited in the third borehole annulus.

15. The method of claim 9, wherein pumping the corrosion inhibiting fluid into the casing-casing annulus mitigates pressure abnormalities in the casing-casing annulus.

16. The wellbore system of claim 1, further comprising an annulus packer operatively coupled to the production casing, wherein the annulus packer is transitionable from:
an undeployed state where the annulus packer allows the corrosion inhibiting fluid to flow from a downhole end of the production casing into the casing-casing annulus; to
a deployed state in which the annulus packer fluidically seals the corrosion inhibiting fluid in the casing-casing annulus, thereby forming the first corrosion-inhibiting barrier.

17. The wellbore system of claim 1, wherein the corrosion inhibiting fluid comprises corrosion inhibiting diesel fluid.

18. The method of claim 9, wherein pumping corrosion inhibiting fluid into the casing-casing annulus comprises pumping the corrosion inhibiting fluid through the production casing, around a downhole end of the production casing, and into the casing-casing annulus.

19. The method of claim 9, further comprising radially expanding an annulus packer from an unexpanded state to an expanded state to fluidically seal the corrosion inhibiting fluid in the casing-casing annulus, thereby forming the first corrosion-inhibiting barrier

20. The method of claim 9, wherein the corrosion inhibiting fluid comprises corrosion inhibiting diesel fluid.

21. A method, comprising:
arranging an intermediate casing into a wellbore;
arranging a production casing within the intermediate casing to define a casing-casing annulus therebetween;
conveying production tubing into the production casing to define a tubing-casing annulus therebetween, wherein an electric submersible pump (ESP) is coupled to the production tubing;
pumping the corrosion inhibiting fluid through the tubing-casing annulus, around a downhole end of the production casing, and into the casing-casing annulus;
radially expanding an annulus packer from an unexpanded state to an expanded state to fluidically seal the corrosion inhibiting fluid in the casing-casing annulus, thereby forming the first corrosion-inhibiting barrier;
radially expanding a production packer from an unexpanded state to an expanded state to fluidically seal corrosion inhibiting fluid in the tubing-casing annulus, thereby forming a second corrosion-inhibiting barrier.
